(19) United States
(12) Patent Application Publication
(10) Pub. No.: US 2026/0285312 A1
(43) Pub. Date: Sep. 24, 2026

(54) VEHICLE DRIVING ASSISTANCE

(71) Applicant: Ford Global Technologies, LLC, Dearborn, MI (US)

(72) Inventors: Keith Weston, Canton, MI (US); Brendan Francis Diamond, Naples, FL (US); Andrew B. Brown, Royal Oak, MI (US); Michael Alan McNees, Flat Rock, MI (US); Andrew Denis Lewandowski, Sterling Heights, MI (US)

(73) Assignee: Ford Global Technologies, LLC, Dearborn, MI (US)

(21) Appl. No.: 19/085,030

(22) Filed: Mar. 20, 2025

(51) Int. Cl. B60W 30/18; B60W 50/16; B60W 30/14; B60W 50/14; G06V 20/59

(52) U.S. Cl. CPC B60W 30/18; B60W 50/16; B60W 30/143; B60W 2050/143; B60W 2520/10; B60W 2530/10; B60W 2552/30; B60W 2552/35; B60W 2552/53; B60W 2554/404; B60W 2554/4043; B60W 2556/40; B60W 2720/10; G06V 20/597

(57) ABSTRACT

A computer includes a processor and a memory, the memory stores instructions executable by the processor to determine a deviation between a digitally mapped version of an upcoming road feature and an upcoming road feature detected at a vehicle. The instructions can additionally be to determine, based on a speed of the vehicle, a time interval available prior to the vehicle encountering the deviation between the digitally mapped version and the detected upcoming road feature. The instructions can further be to actuate a component, during the time interval, for a transition from a first assisted driving mode to a second assisted driving mode.

### BACKGROUND

In a driving environment a vehicle operator may utilize an assisted driving mode, which may permit the operator to remove both hands from a steering wheel of the vehicle. An assisted driving mode can include adaptive cruise control, which may control vehicle speed based on inputs including vehicle sensor data. At times, an operator may be requested to assume manual control of the vehicle.

### BRIEF DESCRIPTION OF THE DRAWINGS

FIG. 1 is a diagram illustrating an example vehicle traveling on a road.

FIG. 2 is a diagram of an example vehicle encountering a curve in a road.

FIG. 3 is a diagram of an example vehicle encountering an inclining road portion.

FIG. 4 is a flowchart of an example process for actuating a component for vehicle driving assistance.

### DETAILED DESCRIPTION

Disclosed herein are systems and methods for a vehicle to transition from a first driving mode to a second driving mode based on a deviation between a digitally mapped version of an upcoming road feature and an upcoming road feature detected or sensed by the vehicle’s sensors. While operating on a road during hands-free driving assistance mode of operation of a vehicle, a vehicle computer may utilize a digital map along with input signals from various sensors, e.g., sensors of a global positioning system or GPS, lateral and longitudinal accelerometers, radar sensors, lidar sensors, etc., to permit an operator to pilot the vehicle in a hands-free driving mode at a speed recommended by the vehicle’s adaptive cruise control system. In an example, based on road features sensed or detected by the vehicle’s sensors agreeing with road features present on a digitally mapped version of the road, the vehicle’s computer may continue to permit hands-free operation and adaptive cruise control of the vehicle. Accordingly, an operator can benefit from a hands-free experience at an appropriate speed in a variety of driving environments.

A digitally mapped version of a road, which may include features such as curvature of an upcoming portion of a road, road gradient (e.g., inclining or declining), road markings (e.g., lane markings, signposts, etc.), may occasionally deviate from sensed or detected upcoming road features. In an example, an upcoming road may include a curvature that deviates from a curvature represented in a digital map stored in a computer memory of the vehicle. In an example, while engaging the curve in the road during hands-free operation of the vehicle, an operator may perceive that a speed recommended by an adaptive cruise control system does not accurately suit the driving environment. In an example, based on such a perception, an operator may swiftly place one or more hands into contact with the steering wheel and/or manually decrease the vehicle speed. Such perceptions can degrade the driving experience facilitated by the hands-free and adaptive cruise control systems.

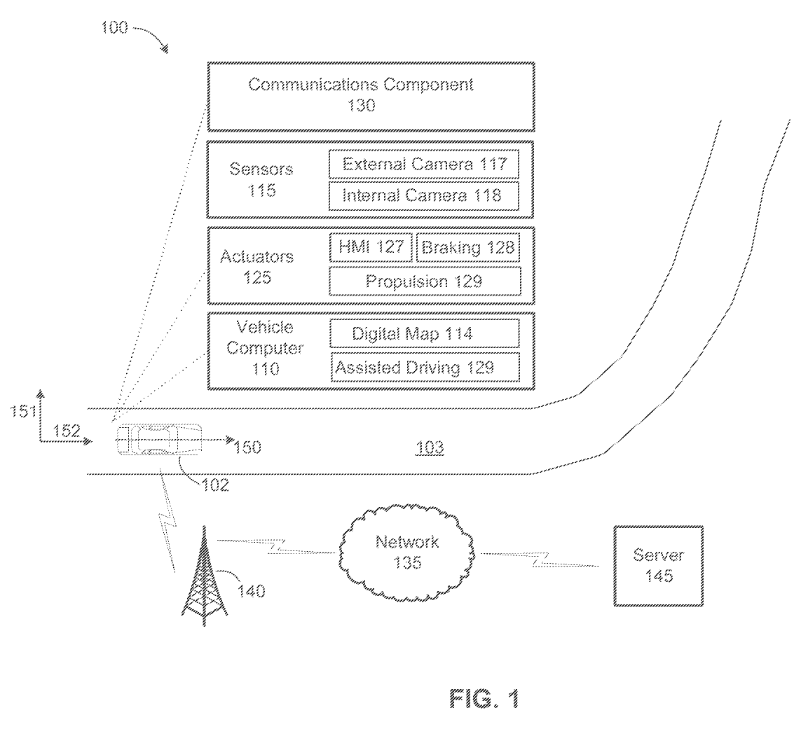

In an example, a computer (e.g., vehicle computer 110 of FIG. 1) can determine a deviation between a digitally mapped version of an upcoming road feature and an upcoming road feature sensed or detected at a vehicle. In an example, the computer can access a memory that identifies a location at which the deviation between the digitally mapped version of the upcoming road feature and the sensed or detected road feature. Based on a speed of the vehicle, the vehicle computer can determine a time interval available prior to the vehicle encountering road feature. During the time interval, the vehicle computer can actuate a component, such as a component of a human-machine interface (HMI) that notifies an operator of the deviation between the digitally mapped version and the sensed or detected upcoming road feature. Such notification can permit the driver to place one or more hands into contact with the vehicle steering wheel and/or decelerate the vehicle so as to proceed to the upcoming road feature with ease.

Herein, a deviation means a difference between digital map data and sensed or detected road conditions that result in a change to a vehicle status, sensed or detected path of a road, or sensed or detected conditions of a road surface. A deviation can be determined based on detected conditions or measurements of an environment in which a vehicle is operating differing from conditions or measurements specified in map data. Alternatively or additionally a deviation can be determined based on a value or values of vehicle operating data (i.e., data describing the movement or operation of the vehicle) differing from vehicle operating data differing from a value or values expected based on map data. A deviation is accordingly specified in terms of a physical quantity or measurement, such as a road grade, a road curvature a vehicle speed, a vehicle steering angle, a vehicle yaw rate, etc. Typically, a deviation is determined to exist when a difference between stored (i.e., based on map data) values differ from real-time values (i.e., based on vehicle sensor data) for the physical quantity or measurement exceeds a threshold. With respect to a vehicle status, for example, a deviation can be digital map data depicting a speed of greater than 20% up to 32 kilometers per hour or more than 10% above 32 kilometers per hour beyond an appropriate speed as sensed or detected by sensors (115 of FIG. 1) of a vehicle. In another example, a deviation can be digital map data that would result in a rate of change to vehicle speed (i.e., acceleration or deceleration) greater than 0.061 meters/second². In another example, a deviation can be digital map data that would result in a steering angle above 10 degrees at speeds less than 32 kilometers per hour and above three degrees at speeds greater than 32 kilometers per hour. In another example, a deviation can be digital map data that would result in a vehicle yaw rate of greater than 10 degrees per second.

With respect to detected path of a road, a deviation can result from digital map data depicting curvature of a portion of a road that is 20% greater than the curvature of the road as sensed or detected by the vehicle’s sensors. In another example, a deviation can result from digital map data depicting an incline (i.e., positive or uphill, negative or downhill) that is 20% less than an incline sensed or detected at a vehicle. With respect to detected condition of a road surface, a deviation can result from digital map data depicting a road surface as being paved while the road surface sensed or detected by the vehicle’s sensors indicates that the road surface is less than 80% paved. In another example, a deviation can result from digital map data depicting a road as including lane markings while one or more external cameras (e.g., 117 of FIG. 1) do not sense or detect lane markings.

Herein, an operator means an entity providing input to control the vehicle. Thus, an operator can include a human operator or a vehicle computer unless explicitly stated otherwise or clearly one or the other from context.

In an example, a system includes a computer that includes a processor and memory, the memory storing instructions executable by the processor to determine a deviation between a digitally mapped version of an upcoming road feature and an upcoming road feature detected at a vehicle. The instructions are additionally to determine, based on a speed of the vehicle, a time interval available prior to the vehicle encountering the deviation between the digitally mapped version and the detected upcoming road feature. The instructions are additionally to actuate a component, during the time interval, for a transition from a first assisted driving mode to a second assisted driving mode.

In an example, the component outputs an audio signal or a vibration in a seat and/or steering wheel of the vehicle.

In an example, the instructions are additionally to actuate the component to decrease speed of the vehicle.

In an example, the instructions are additionally to initiate a timer at the vehicle after executing the instructions to actuate the component and to actuate a second component of the vehicle to decrease speed based on expiration of the timer.

In an example, the deviation between the digitally mapped version of the upcoming road feature and the detected upcoming road feature is based on detection by a second vehicle of the deviation between the digitally mapped version of the upcoming road feature and the detected upcoming road feature.

In an example, the deviation between the digitally mapped version of the upcoming road feature and the detected upcoming road feature is based on detection by a second vehicle of the deviation between the digitally mapped version of the upcoming road feature and the detected upcoming road feature and based on an output from a facial recognition component of the second vehicle indicating emotional discomfort of the operator or a passenger of the second vehicle.

In an example, the deviation between the digitally mapped version of the upcoming road feature and the detected upcoming road feature is based on detection by a second vehicle of the deviation between the digitally mapped version of the upcoming road feature and the detected upcoming road feature and based on data from a lateral accelerometer of the second vehicle.

In an example, the deviation between the digitally mapped version of the upcoming road feature and the detected upcoming road feature is based on detection by a second vehicle of the deviation between the digitally mapped version of the upcoming road feature and the detected upcoming road feature and based on data from a longitudinal accelerometer of the second vehicle.

In an example, the deviation between the digitally mapped version of the upcoming road feature and the detected upcoming road feature is based on a probability of a presence of the deviation, based on inputs from a database utilizing inputs of operators of one or more other vehicles, between the digitally mapped version of the upcoming road feature and the detected upcoming road feature.

In an example, wherein an output of a human-machine interface is based on the probability.

In an example, the deviation between the digitally mapped version of the upcoming road feature and the detected upcoming road feature includes a difference between road curvature represented on the digital map and a detected road curvature.

In an example, the deviation between the digitally mapped version of the upcoming road feature and the detected upcoming road feature includes a difference between a recommended speed based on the digital map and a recommended speed based on the detected upcoming road feature exceeding a measure of roughness of the surface of the upcoming road.

In an example, the deviation between the digitally mapped version of the upcoming road feature and the detected upcoming road feature includes a difference between an expected and a detected angle of incline of the upcoming road.

In an example, the time interval is based on a geo-fence boundary between a location of the vehicle and the detected upcoming road feature.

In an example, the first assisted driving mode is a hands-off driving mode, and the second assisted driving mode is a hands-on driving mode.

In an example, the deviation between the digitally mapped version of the upcoming road feature and the detected upcoming road feature is based on road descriptions from the digital map and detected road markings.

In an example, the time interval is based on gross train weight of the vehicle.

An example method includes determining a deviation between a digitally mapped version of an upcoming road feature and an upcoming road feature detected at a vehicle. The example method additionally includes determining, based on a speed of the vehicle, a time interval available prior to the vehicle encountering the deviation between the digitally mapped version and the detected upcoming road feature. Example method further includes actuating a component, during the time interval, for a transition from a first assisted driving mode to a second assisted driving mode.

In an example, the method includes actuating the component to decrease speed of the vehicle.

In an example, the deviation between the digitally mapped version of the upcoming road feature and the detected upcoming road feature can be based on a combined deviation of two or more of a difference between road curvature represented on the digital map and a detected road curvature, a sensed or detected speed of the vehicle, a measure of the roughness of a road, a measure of road friction, night versus day driving, and ambient weather conditions.

FIG. 1 is a diagram illustrating an example vehicle traveling on a road. Diagram 100 includes vehicle 102, which is a land vehicle such as a car, truck, sport-utility vehicle, etc. Vehicle 102 includes vehicle computer 110, vehicle sensors 115, actuators 125 to actuate various vehicle components, such as components of a human-machine interface (HMI) 127, braking component 128, propulsion component 129, steering components, etc.). Vehicle 102 can additionally include vehicle communications component 130. Communications component 130 can permit computer 110 of vehicle 102 to communicate with one or more of transceiver 140, server 145, such as via network 135. Vehicle computer 110 includes a processor and a memory. The memory can include one or more forms of computer-readable media, and stores instructions executable by vehicle computer 110 for performing various operations, including those disclosed herein.

Vehicle computer 110 may operate vehicle 102 in an autonomous, a semi-autonomous mode (i.e., assisted), or a nonautonomous (i.e., manual) mode. For purposes of this disclosure, an autonomous mode is defined as one in which each of vehicle 102 propulsion, braking, and steering are controlled by vehicle computer 110; in a semiautonomous (i.e. assisted) mode, vehicle computer 110 controls one or two of propulsion, braking, and steering of vehicle 102; in a nonautonomous (i.e., manual) mode a human operator controls each of vehicle 102 propulsion, braking, and steering. Accordingly, vehicle 102 may be capable of some or all of the levels of automation specified by the Society of Automotive Engineers SAE J3016 Levels of Driving Automation™. According to SAE J3016 level 0, assistance features can include providing notifications and momentary assistance, to level 5, in which vehicle 102 can pilot itself under all conditions. At an intermediate level of autonomy (e.g., SAE J3016 level 3), vehicle 102 can be piloted autonomously, but an operator may be requested to assume control of vehicle 102 based on output data from a computer 110. At an intermediate level of autonomy, computer 110 can utilize digital map 114 to predict the path of vehicle 102 along road 103. At the intermediate level of autonomy output data from sensors 115 can be utilized to complement data from digital map 114 to guide vehicle 102 along road 103.

Vehicle computer 110 may include programming to operate one or more of vehicle 102 brakes, propulsion (e.g., control of the speed of the vehicle by controlling one or more of an internal combustion engine, electric motor, hybrid engine, etc.), steering, climate control, interior and/or exterior lights, etc., as well as to determine whether and when vehicle computer 110, as opposed to a human operator, is to control such operations.

Vehicle computer 110 may include or be communicatively coupled to, e.g., communications component 130 as described further below, more than one processor, e.g., included in electronic controller units (ECUs) or the like included in vehicle 102 for monitoring, actuating, and/or controlling various vehicle actuators 125, e.g., a powertrain actuator, a brake actuator, a steering actuator, etc. Further, vehicle computer 110 may communicate, via communications component 130, with a navigation system that uses signals from a satellite positioning system, e.g., GPS. As an example, vehicle computer 110 may request and receive location data of vehicle 102. The location data may be in a known form, e.g., geo-coordinates in a global-reference frame (i.e., latitudinal and longitudinal coordinates).

Vehicle computer 110 can be generally arranged for communications with communications component 130 utilizing an internal wired and/or wireless network, e.g., a bus or the like of vehicle 102, such as a controller area network (CAN) or the like, and/or other wired and/or wireless mechanisms. Utilizing a communications network of vehicle 102, vehicle computer 110 can transmit messages to various devices in vehicle 102 and/or receive messages from the various devices, e.g., vehicle sensors 115, actuators 125, which may include human-machine interface (HMI 127), propulsion and/or powertrain components (e.g., propulsion component 129), etc. Alternatively or additionally, in examples in which the vehicle computer 110 actually comprises a plurality of devices, a communications network of vehicle 102 may be used for communications between devices represented as vehicle computer 110. Further, as mentioned below, various controllers and/or vehicle sensors 115 may provide data to vehicle computer 110.

Vehicle sensors 115 may include a variety of devices to provide data to vehicle computer 110. For example, vehicle sensors 115 may include Light Detection and Ranging (LIDAR), long-range and short range radar sensors, acoustic sensors, etc., disposed on a top of vehicle 102, behind vehicle 102 front windshield, around vehicle 102, etc., that provide relative locations, sizes, and shapes of objects and/or conditions surrounding vehicle 102, including objects on and/or features of road 103. Sensors 115 can include radar sensors 115, which may be fixed to bumpers of vehicle 102, can provide data to provide range and time before encountering road features (e.g., based on vehicle speed) relative to the location of vehicle 102. Sensors 115 can include a hands-on/hands-off steering wheel sensor, which determines whether an operator of vehicle 102 has placed one or more hands into contact with the steering wheel of vehicle 102. Sensors 115 can include a lateral accelerometer, which operates to sense or detect acceleration in the lateral direction with respect to vehicle 102 (as given by arrow 151 and FIG. 1). Sensors 115 can include a longitudinal accelerometer, which operates to sense or detect acceleration in the longitudinal direction with respect to vehicle 102 (as given by arrow 152 in FIG. 1). Sensors 115 can include a torque sensor, which operates to measure output powertrain data (e.g., gross train weight) that can indicate whether vehicle 102 is towing a trailer (e.g., a camper trailer, a fifth wheel travel trailer, etc.). Sensors 115 can include a weight sensor, which operates to measure whether vehicle 102 is partially or fully loaded with passengers, cargo, etc., which can be included in the gross train weight data of the vehicle.

Vehicle sensors 115 can include external camera(s) 117, e.g., front view, side view, rear view, etc., to provide images of the driving environment of vehicle 102. Vehicle sensors 115 can additionally include internal cameras 118, which may include a camera mounted on the dashboard, rearview mirror, or at another location within an interior portion of vehicle 102. Camera(s) 117 can be of sufficient resolution to digitize scenes that include facial images of live persons positioned, for example, in an operator’s position of vehicle 102. In an example, images of the facial and/or other features of an operator or passenger of vehicle 102 can be compared with a set of stored image parameters to permit a computer of the vehicle to identify the person. In addition, camera(s) 117 may operate to extract facial geometry and/or facial expressions of an operator and/or a passenger of vehicle 102 visible to camera 117. Facial recognition algorithms may utilize a distance between landmarks identified in an image such as the operator’s eyes, a distance from the forehead to the chin of the operator, a distance between the nose and the mouth of the operator, depth of the operator’s eye sockets, shape of cheek bones, and/or contour of the lips, ears, and chin of the operator. In the example of FIG. 1, internal cameras 118 may measure changes in the facial expression of an operator, such as a change in the distance between an operator’s eyes and eyebrows, a change in the shape of the eyebrows, a head movement, a mouth movement, flaring of the nostrils, etc., which may be utilized to determine whether an operator’s face indicates unease.

External camera(s) 117 and internal cameras 118 can operate to detect electromagnetic radiation in a range of wavelengths, such as visible light, infrared radiation, ultraviolet light, or some range of wavelengths including visible, infrared, and/or ultraviolet light. For example, external camera(s) 117 and internal cameras 118 can include image sensors such as charge-coupled devices (CCD), active-pixel sensors such as complementary metal-oxide semiconductor (CMOS) sensors, etc.

Actuators 125 are implemented via circuits, chips, indicators (e.g., lamps, audible indicators, haptic indicators, vibration actuators of HMI 127 motors (e.g., stepper motors), or other electronic and/or mechanical components that can actuate various vehicle subsystems in accordance with appropriate control signals. Actuators 125 may be used to control various propulsion components, including braking, speed control, and steering of vehicle 102.

In the context of the present disclosure, a vehicle component is one or more hardware components adapted to perform a mechanical, electric, or electro-mechanical function or operation—such as moving vehicle 102, decreasing the speed of or stopping the vehicle, steering the vehicle, providing a stimulus to an indicator for viewing by the operator of vehicle 102, etc. Non-limiting examples of actuators 125 include an actuator of a propulsion input component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a component of a human-machine interface, etc.

In addition, computer 110 can be configured to communicate via a vehicle-to-vehicle communication component 130 with devices outside of vehicle 102, e.g., through a vehicle-to-vehicle (V2V) or vehicle-to-infrastructure (V2X) wireless communications to another vehicle, to transceiver 140 (e.g., via radio frequency communications) and/or (e.g., via network 135) server 145. Communications component 130 can include one or more mechanisms by which vehicle computer 110 may communicate, including any desired combination of wireless (e.g., cellular, wireless, satellite, microwave, and radio frequency) communication mechanisms and any desired network topology (or topologies when a plurality of communication mechanisms are utilized). Exemplary communications provided via communications component 130 include cellular, Bluetooth®, IEEE 802.11, dedicated short range communications (DSRC), and/or wide area networks (WAN), including the Internet, providing data communication services.

Network 135 includes one or more mechanisms by which a vehicle computer 110 may communicate with transceiver 140, server 145, and/or a second vehicle that may be similar to that of vehicle 102. Accordingly, network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Example communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services. Server 145 can be a conventional computing device, i.e., including one or more processors and one or more memories, programmed to provide operations such as disclosed herein. Further, server 145 can be accessed via the network 135, e.g., the Internet or some other wide area network.

In an example, a vehicle 102 may proceed along path 150 on road 103. At times, such as during operation of vehicle 102 in an autonomous or semi-autonomous (i.e., assisted) mode, computer 110 of vehicle 102 may execute computer instructions to utilize data from digital map 114, which permits the computer to predict features of road 103 In the example of FIG. 1, based on inputs from digital map 114, computer 110 can predict an upcoming curve or bend in road 103. In another example, based on inputs from digital map 114, computer 110 can predict locations along road 103 at which road gradients are present, such as inclines and declines in the road. In another example, based on inputs from digital map 114, computer 110 can predict whether road markings are present along road 103, whether vehicle 102 is to encounter a stop sign, traffic light, yield sign, wrong way sign, speed limit sign, or any other marking present along road 103. In an example, computer 110 may execute computer instructions to provide adaptive cruise control of vehicle 102. Accordingly, vehicle computer 110 may increase or decrease the speed of vehicle 102 based on detected road features from sensors 115 and based on inputs from digital map 114.

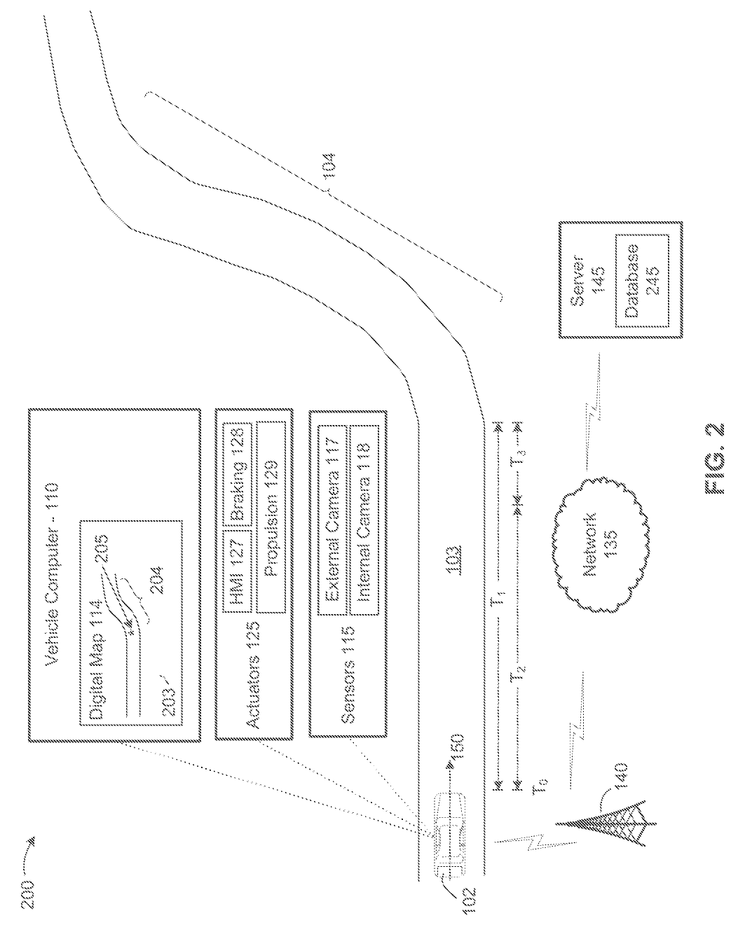

FIG. 2 is a diagram 200 of an example vehicle encountering a curve in a road. As seen in FIG. 2, as vehicle 102 travels along path 150, vehicle sensors 115 may sense or detect curve 104 in road 103. An operator of vehicle 102 may utilize an autonomous or semi-autonomous (assisted) driving mode, in which instructions executed by computer 110 can allow hands-free piloting of the vehicle. Further, in an autonomous or semi-autonomous (assisted) driving mode, an operator of vehicle 102 may utilize an adaptive cruise control feature, wherein the speed of vehicle 102 is selected via execution of instructions by computer 110. As vehicle 102 travels along road 103, computer 110 may access digital map data 203 describing road 103, which can be stored in a memory available to the computer.

In the example of FIG. 2, digital map data 203 of road 103 may indicate an upcoming feature, such as curve 204. However, curve 204 of digital map data 203 may not accurately represent curve 104 of road 103. As seen in FIG. 2, curve 204 may represent a curve having less curvature than the curvature of sensed or detected curve 104. Accordingly, in the example of FIG. 2, a deviation exists between the digitally mapped version of the upcoming road feature (e.g., curve 204) and the sensed upcoming road feature (e.g., curve 104). As a result of such deviation, as vehicle 102 encounters curve 104, an operator of vehicle 102 may perceive that vehicle 102 is traveling at a speed that may be perceived as being greater than a speed that is comfortable to an operator or a passenger of vehicle 102.

Thus, in an example, an operator of vehicle 102 may exhibit a facial expression of uneasiness with a current rate of speed. In another example, an operator of vehicle 102 may exhibit a facial expression of unease in response to being pulled in a lateral direction based on vehicle 102 rounding curve 104. Such facial expressions can be detected utilizing internal cameras 118 mounted on the dashboard of vehicle 102, a rearview mirror, or another location, and directed toward the face or head of an operator of vehicle 102. Such facial expressions can include a change in distance between an operator’s eyes and eyebrows, a change in the shape of the eyebrows, a head movement, mouth movement, flaring of the nostrils, etc. Facial expressions can be determined by any suitable technique, such as utilizing a classifier that can detect differences between facial features of an operator. In an example, differences can be detected utilizing a histogram of gradients (e.g., to enumerate occurrences of gradient orientation of facial features within images of an operator), Haar cascading (e.g., to detect features within images, irrespective of their scale in an image and location within an image), detection and localization of two-dimensional facial landmarks utilizing three-dimensional vertices regression, and/or classification network to apply convolution blocks followed by down sampling to encode an input image into multi-level feature representations.

In the example of FIG. 2, vehicle computer 110 may execute instructions to notify the operator of vehicle 102 (e.g., via HMI 127) to place one or more hands into contact with the steering wheel of vehicle 102 via HMI 127. Alternatively or in addition, based on input data from vehicle computer 110, HMI 127 may actuate a vibration component in the seat at the operator’s position of vehicle 102. Alternatively or in addition, based on input data from vehicle computer 110, HMI 127 may actuate an audio signal (e.g., a chime, a beep, etc.) to notify the operator to place one or more hands into contact with the steering wheel of vehicle 102. In another example, vehicle computer 110 can, without input from an operator, decrease the speed of vehicle 102.

In the example of FIG. 2, based on metadata stored in a memory accessible to vehicle computer 110, the vehicle computer can identify an upcoming road feature with a symbol (e.g., asterisk (*) 205) to signify a location of a deviation between a digitally mapped version of an upcoming road feature and a sensed or detected upcoming road feature as sensed by one or more of sensors 115. Accordingly, as seen in FIG. 2, an entrance to curve 104 has been associated with data representing curve 204 via symbol 205 to signify a location (expressed via) latitude/longitude) at which a deviation between the digitally mapped version of the upcoming feature and the sensed or detected upcoming road feature occurs. Thus, as vehicle 102 approaches the entrance to curve 104, an operator of the vehicle can be made aware of the deviation. Accordingly, an operator may choose to place one or more hands into contact with a steering wheel of vehicle 102. Alternatively or in addition, the operator may choose to reduce the speed of vehicle 102. The operator can thus proactively modify an adaptive cruise control setting and/or an autonomous or semi-autonomous (assisted) driving mode prior to encountering the upcoming feature (e.g., curve 104).

In an example, instructions executed by computer 110 can notify the operator of vehicle 102 during an expected time interval (e.g., T₁ in FIG. 2) prior to vehicle 102 reaching a location of an upcoming road feature. Accordingly, during a time interval T₁, such as at time T₀at the beginning oftime interval T₁, vehicle computer 110 can actuate (e.g., via HMI 127) a visual notification, an audio notification (e.g., a chime, beep, etc.) to indicate a deviation between a digitally mapped version of an upcoming road feature and an upcoming road feature detected at vehicle 102. In an example, time interval T₁ can be determined, via instructions executed by vehicle computer 110, based on a speed of vehicle 102. Thus, an operator of vehicle 102 may have ample time to manually decrease the speed of vehicle 102, place one or more hands into contact with the steering wheel of vehicle 102 or take another precautionary measure prior to encountering curve 104. In an example, time interval T₁ can include a duration of five seconds, 10 seconds, 15 seconds, or another duration. In an example, time interval T₁ can be computed by computer 110 based on the gross train weight of vehicle 102. In such an example, time interval T₁ can be increased by one second, two seconds, five seconds, etc., based on the weight of cargo or passengers within vehicle 102 and/or based on whether vehicle 102 is towing a trailer (e.g., a camper trailer, a fifth wheel travel trailer, etc.).

In an example, computer 110 can initiate a timer after executing the instructions to actuate a component of HMI 127 and actuate a second component of the vehicle to decrease speed based on expiration of the timer. For example, based on data from vehicle computer 110, HMI 127 can actuate an audio signal (e.g., a chime, a beep, etc.) at time T₀at the beginning of time interval T₁. For example, at time T₀, HMI 127 may actuate a visual indicator to inform an operator of vehicle 102 to place at least one hand into contact with the steering wheel of the vehicle. Based on an absence of a signal from a steering wheel sensor (115) indicating that one or more of the operator’s hands have been placed into contact with the steering wheel, HMI 127 can actuate a second visual indicator (e.g., during time interval T₂), to inform an operator of vehicle 102 to place at least one hand into contact with the steering wheel. Alternatively or in addition, computer 110 may actuate propulsion component 129, which can operate to decrease the speed of vehicle 102. Propulsion component 129 can be actuated at additional times during time interval T₃, which can operate to further decrease the speed of vehicle 102 based on a continued absence of a signal that one or more of the operator’s hands have been placed into contact with the steering wheel.

In the example of FIG. 2, a location of a deviation between a digitally mapped version of an upcoming road feature and a sensed or detected upcoming road feature may be transmitted to vehicle 102 from server 145 via network 135 and transceiver 140. Locations of deviations between a digitally mapped version of an upcoming road feature and a sensed or detected upcoming road feature may be stored in database 245 of server 145. In an example, a location of a deviation can be indicated utilizing data transmitted from one or more vehicles similar to vehicle 102 that have encountered a deviation between a digitally mapped version of an upcoming road feature and a sensed or detected upcoming road feature. In the example of FIG. 2, a vehicle encountering the deviation between a digitally mapped version of an upcoming road feature and a sensed or detected upcoming road feature may include output signals from sensors 115 (e.g., a lateral accelerometer) of the vehicle similar to vehicle 102. In an example, based on a certain number of vehicles (e.g., at least 10, at least 20, etc.,) similar to vehicle 102 having encountered a deviation at a particular location, server 145 (e.g., interacting with database 245) can notify vehicle 102 of such deviation (e.g., via symbol 205). In another example, based on a significant percentage of other vehicles (e.g., at least 40%, 50%, 60%, etc.) having encountered the deviation between a digitally mapped version of an upcoming road feature and a sensed or detected road feature, server 145 can notify vehicle 102 of the deviation. In another example, based on a small percentage of vehicles (e.g., less than 5%, less than 10%, less than 15%, etc.) having encountered a deviation, server 145 may store the deviation as merely a probability of a deviation and refrain from notifying vehicle 102 until a larger probability (e.g., greater than 25%, 30%, 40%, etc.) is reached.

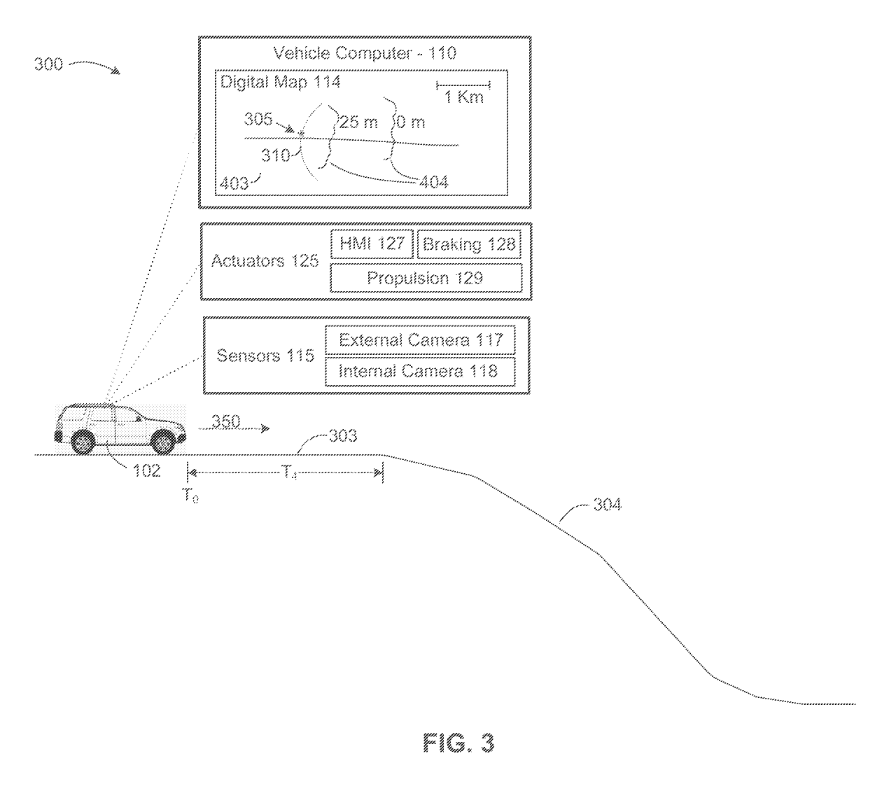

FIG. 3 is a diagram 300 of an example vehicle encountering an inclining road (i.e., the vehicle 102 is travelling on a downgrade, or downhill). As seen in FIG. 3, as vehicle 102 travels along path 350, vehicle sensors 115 may sense or detect declining road portion 304 of road 103. In this disclosure, an inclining road means a positive (uphill) or negative (downgrade or downhill) angle of inclination in a road (e.g., declining road portion 304 of road 303). An operator of vehicle 102 may utilize an autonomous or semi-autonomous (assisted) driving mode, in which instructions executed by computer 110 can allow hands-free piloting of the vehicle. An operator of vehicle 102 may utilize an adaptive cruise control feature, wherein the speed of vehicle 102 is selected via execution of instructions by computer 110. As vehicle 102 travels along road 303, computer 110 may access digital map data 403 of road 303, which can be stored in a memory available to the computer.

In the example of FIG. 3, digital map data 403 of road 303 may indicate an upcoming feature, such as declining road portion 304 as represented by contour lines 404. However, contour lines 404 of digital map data 403 may not accurately represent declining road portion 304 of road 303. As seen in FIG. 3, contour lines 404 may represent a road having a smaller angle of decline (e.g., negative inclination) than the angle of declination sensed or detected by sensors 115. Accordingly, in the example of FIG. 3, a deviation exists between the digitally mapped version of the upcoming road feature (e.g., as represented by contour line 404) and the sensed upcoming road feature (e.g., declining road portion 304). As a result of such deviation, as vehicle 102 encounters declining road portion 304, an operator of vehicle 102 may perceive that vehicle 102 is traveling at a speed that may be perceived as being greater than a speed that is comfortable to an operator or a passenger of vehicle 102. Accordingly, an operator of vehicle 102 may exhibit a facial expression of uneasiness with a current rate of speed. In an example, such facial expressions can be detected utilizing internal cameras 118. Such facial expressions can include a change in distance between an operator’s eyes and eyebrows, a change in the shape of the eyebrows, a head movement, a mouth movement, a flaring of the nostrils, etc.

In the example of FIG. 3, vehicle computer 110 may execute instructions to notify the operator of vehicle 102 (e.g., via HMI 127) to place one or more hands into contact with the steering wheel of vehicle 102. Alternatively or in addition, based on input data from vehicle computer 110, HMI 127 may actuate a vibration component in the seat at the operator’s position of vehicle 102. Alternatively or in addition, based on input data from vehicle computer 110, HMI 127 may actuate an audio signal (e.g., a chime, a beep, etc.) to notify the operator to place one or more hands into contact with the steering wheel of vehicle 102. In another example, vehicle computer 110 can, without input from an operator, decrease the speed of vehicle 102.

In the example of FIG. 3, symbol 305 can signify a location (as indicated by geo location data, typically a latitude/longitude stored as digital map data 403, at which a deviation between the digitally mapped version of the upcoming feature and the sensed or detected upcoming road feature occurs. Thus, as vehicle 102 approaches declining road portion 304, an operator of vehicle 102 can be made aware of the deviation. Accordingly, an operator may choose to place one or more hands into contact with a steering wheel of vehicle 102. Alternatively or in addition, the operator may choose to reduce the speed of vehicle 102.

In an example, vehicle computer 110 can notify the operator of vehicle 102 during a time interval (e.g., T₄ in FIG. 3) prior to vehicle 102 encountering an upcoming road feature. Accordingly, during a time interval T₄, such as at time T₀ at the beginning of time interval T₄, vehicle computer can actuate a visual notification (e.g., via HMI 127), an audio notification (e.g., a chime, beep, etc.) to indicate a deviation between a digitally mapped version of an upcoming road feature and an upcoming road feature detected at vehicle 102. In an example, time interval T₄ can be determined, via instructions executed by vehicle computer 110, based on a speed of vehicle 102. Thus, an operator of vehicle 102 may have ample time to decrease the speed of vehicle 102, place one or more hands into contact with the steering wheel of vehicle 102 or take another precautionary measure prior to encountering declining road portion 304.

In an example, based on data from vehicle computer 110, HMI 127 can initiate an audio signal (e.g., a chime, a beep, etc.) at time T₀ at the beginning of time interval T₄. For example, at time T₀, HMI 127 may actuate a visual indicator to inform an operator of vehicle 102 to place at least one hand into contact with the steering wheel of the vehicle. Based on an absence of a signal from a steering wheel sensor (115) indicating that one or more of the operator’s hands have been placed into contact with the steering wheel, HMI 127 can actuate a second visual indicator to inform an operator of vehicle 102 to place at least one hand into contact with the steering wheel. Alternatively or in addition, computer 110 may actuate propulsion component 129, which can operate to decrease the speed of vehicle 102. Propulsion component 129 can be actuated at additional times during time interval T₄, which can operate to further decrease the speed of vehicle 102 based on an absence of a signal indicating that one or more of the operator’s hands have been placed into contact with the steering wheel.

Alternatively or in addition, digital map 114 can utilize a geofence, as indicated by geofence boundary 310 of FIG. 3. A geofence means a virtual geographic boundary, defined in a global reference frame that permits instructions executable by computer 110 to initiate a notification based on vehicle 102 crossing the geofence boundary. In an example, geofence boundary 310 can represent a portion of a geofence that at least partially surrounds contour lines 404 that represents declining road portion 304. In the example of FIG. 3, each contour line represents a change of approximately 25 meters in elevation of road 303. Accordingly, contour lines 404 of digital map 114 indicate a 25-meter negative incline over one kilometer portion of declining road portion 304. The location of geofence boundary 310 can be located, for example, 0.5 kilometers from a first contour line of contour lines 404 or at any other distance from contour lines 404 (e.g., 0.25 kilometers, 0.4 kilometers, 0.75 kilometers, etc.). Thus, an operator of vehicle 102 may have ample distance to place one or more hands into contact with the steering wheel of vehicle 102, decrease the vehicle’s speed, or take another precautionary measure.

In the example of FIG. 3, a location of a deviation between a digitally mapped version of an upcoming road feature and a sensed or detected upcoming road feature may be transmitted to vehicle 102 from server 145 via network 135 and transceiver 140 (of FIG. 1). Locations of deviations between digitally mapped versions of upcoming road features and sensed or detected upcoming road features may be stored in database 245 of server 145. In an example, a location of a deviation can be indicated utilizing data transmitted from one or more vehicles similar to vehicle 102 that have encountered a deviation between a digitally mapped version of an upcoming road feature and a sensed or detected upcoming road feature. In the example of FIG. 3, a deviation between the digitally mapped version of an upcoming road feature and a sensed or detected upcoming road feature may be determined utilizing output signals from sensors 115 (e.g., a longitudinal accelerometer) of the vehicle similar to vehicle 102.

In addition to deviations in road curvature (FIG. 2) and angle of inclination (FIG. 3), an upcoming road feature can include surface roughness of a portion of road 103 that exceeds a specified measure of road roughness. A measure of roughness of road 103 can include number of detectable potholes per 100 meters (e.g., five, 10, 15, etc.), uneven surfaces, sunken grades, road construction zones, unpaved or partially paved portions, etc. Accordingly, in such examples, map data can include GPS coordinates of such features, which can allow an operator of vehicle 102 to place one or more hands into contact with the steering wheel of the vehicle, decrease the speed of the vehicle, or take another precautionary measure that results in an operator encountering the upcoming road feature with increased ease.

In an example, a deviation is typically measured or determined with respect to conditions of an environment, for example including a road 103, 303, that are determined based on vehicle sensor data. In such an example, computer 110 can store or have access to a lookup table (or the like) of deviations, which could be in accordance with combinations of attributes or conditions of a road. For example, a detected angle of inclination of a road could deviate from an expected inclination (e.g., as determined from map data 403) by more than a threshold value, the difference between the detected and expected angle being a deviation. However, based on inclination of the road deviating from map data by an additional amount (i.e., a second deviation) in combination with a detected road curvature deviating from a mapped curvature (e.g., as determined from map data 203) by over a threshold curvature value, the deviation thresholds could be stored as a “compound deviation” (i.e., a combination of two or more deviations) according to which the computer 110 actuates a vehicle component (e.g., braking component 128). Alternatively or in addition, a deviation could be dependent on the speed of vehicle 102. For example, a vehicle operator may experience unease based on encountering a curve (e.g., 104) at a relatively high vehicle speed (e.g., 40 kilometers/hour, 50 kilometers/hour, etc.) as opposed to encountering a curve at a relatively low speed (e.g., 25 kilometers/hour, 30 kilometers/hour, etc.). In another example, a deviation between a digitally mapped version of an upcoming road feature and a detected upcoming road feature can be based on a compound deviation of two or more of: a difference between road curvature represented on the digital map and a detected road curvature, a sensed or detected speed of the vehicle, a measure of the roughness of a road, a measure of road friction, night versus day driving, and ambient weather conditions (e.g., rain, snow, ice, mud, etc.).

Threshold values for determining when respective deviations should trigger the computer 110 actuating a vehicle component are typically determined for a model or type of vehicle. For example, deviations for a same map location or area could be different for different types of vehicles; a large sport utility vehicle, for example, might have different threshold values than a small sedan. Deviation thresholds can be determined empirically. For example, a test vehicle of a specified model or type could travel a test track or map area and a user could record levels of ease or comfort when a vehicle is operating according to an expected measurement that deviates from a real measurement by more than a threshold. For example, the vehicle could be operated at respective speeds on a road where an expected curvature is greater than an actual curvature by more than a specified amount. A vehicle occupant could then record unease or comfort, or could rate a level of comfort, as the vehicle is operated through the curvature at the respective speeds, and recording unease could then result in the specified amount being used as a deviation threshold for a road curvature. Further, deviation thresholds could be different depending on a range of expected and actual values. For example, a deviation threshold might be higher for lower curvature values than for higher curvature values.

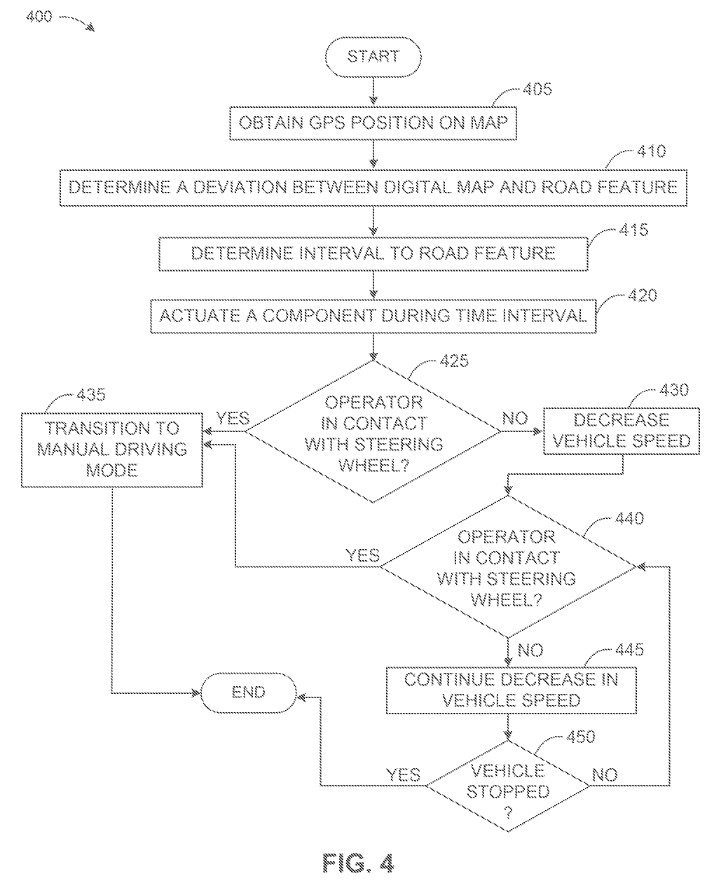

FIG. 4 is a flowchart of an example process 400 for actuating a component for vehicle driving assistance. Blocks of process 400 could be performed via execution of instructions by computer 110. Blocks of process 400 may be executed in the order presented or may be executed in a different order. As a non-limiting overview of the example process 400, an operator of vehicle 102 may utilize an autonomous or semi-autonomous (e.g., assisted) driving mode, which can include adaptive cruise control. Prior to encountering a deviation between a digitally mapped version of an upcoming road feature and an upcoming road feature detected at a vehicle, instructions executable by vehicle computer 110 can determine a time interval available prior to the vehicle encountering the deviation between the digitally mapped version and the detected upcoming road feature. During the time interval, computer 110 may interact with HMI 127 to actuate a display to notify the operator of vehicle 102 to place one or more hands into contact with the steering wheel of the vehicle. Alternatively or in addition, HMI 127 can reduce the speed of vehicle 102. In an example, a location of a deviation between a digitally mapped version of an upcoming road feature and an upcoming road feature sensed or detected by sensors 115 of vehicle 102 can be identified via map data accessible to computer 110. Accordingly, an operator of vehicle 102 can encounter the upcoming road feature with ease, thereby enhancing the operator’s driving experience of the vehicle.

Process 400 begins at block 405, at which vehicle computer 110 obtains a position of vehicle 102 in a global-reference (e.g., GPS) frame. The location of vehicle 102 may be represented on digital map 114, which may be provided or displayed to the operator of vehicle 102. The vehicle can be operated in an autonomous or semi-autonomous (assisted) driving mode. An autonomous or semi-autonomous (assisted) driving mode can include use of an adaptive cruise control capability in which a speed of vehicle 102 is controlled via instructions executed by a processor of computer 110. In an autonomous or semi-autonomous (assisted) driving mode, sensors 115 can be utilized to provide computer 110 with an assessment of the driving environment, including lane markings, signposts, guardrails, upcoming curves in road 103, upcoming changes in the angle of inclination of road 103, etc.

Process 400 may continue at block 410, which can include determining that a deviation exists between a digitally mapped version of an upcoming feature and a sensed or detected upcoming road feature. In an example, a deviation can include a difference in curvature of an upcoming portion of road 103 as sensed or detected by sensors 115 and a digital map depicting curvature of the road. In an example, a deviation can include a difference in inclination (positive or negative angle) of an upcoming portion of road 103 as sensed or detected by sensors 115 and a digital map depicting inclination of the road. In an example, a deviation can include a difference in roughness of an upcoming portion of road 103, such as potholes, uneven surfaces, sunken grades, etc., as sensed or detected by sensors 115 and a digitally mapped version of the upcoming feature (e.g., 203). In an example, a deviation between a digitally mapped version of an upcoming road feature and a detected upcoming road feature can be based on a combined deviation of two or more of: a difference between road curvature represented on the digital map and a detected road curvature, a sensed or detected speed of the vehicle, a measure of the roughness of a road, a measure of road friction, night versus day driving, and ambient weather conditions (e.g., rain, snow, ice, mud, etc.).

Process 400 may continue at block 415, which can include determining a time (e.g., T₁) or a distance (e.g., 0.25 kilometers, 0.4 kilometers, 0.75 kilometers) interval before vehicle 102 encounters an upcoming road feature. In an example, a time interval can be determined by computer 110 executing instructions utilizing a current speed and present location of vehicle 102. In an example, a distance interval can be represented by a geofence boundary 310 that at least partially surrounds (e.g., at a distance of 0.5 kilometer, one kilometer, 1.5 kilometers, etc.) a deviation between a digitally mapped version of an upcoming feature and a sensed or detected upcoming road feature. Based on vehicle 102 reaching the geofence boundary, instructions executable by computer 110 can initiate a notification to the operator of the vehicle.

Process 400 can continue at block 420, which can include computer 110 (via HMI 127) actuating a display visible to the operator of vehicle 102 to request that the operator place at least one hand into contact with the steering wheel of the vehicle. Block 415 can include HMI 127 actuating an audio signal, which may include generation of a chime, beep, or any other audio signal that can be perceived by an operator of vehicle 102. Block 415 can include HMI 127 activating a vibration actuator in the seat at the operator’s position of vehicle 102.

Process 400 can continue at block 425, which can include computer 110 determining whether the operator of vehicle 102 has placed one or more hands into contact with the steering wheel of the vehicle. Block 425 can include receiving a signal or data from a steering wheel sensor (115), which may determine whether one or more of the operator’s hands are currently placed into contact with the steering wheel of the vehicle.

Process 400 can continue at block 430, in which, based on an absence of a signal or data from a steering wheel sensor of the vehicle, computer 110 may activate an actuator 125 (e.g., braking component 128) to decrease the speed of vehicle 102. In an example, actuator 125 can interact with propulsion component 129, to reduce the speed of vehicle 102 by five kilometers per hour, 10 kilometers per hour, or another decrease in the vehicle’s speed.

At block 435, which may follow either of the blocks 425, 440, based on a signal or data from a steering wheel sensor of the vehicle, computer 110 can transition from a first driving mode (e.g., autonomous or semi-autonomous) to a second driving mode (e.g., a manual driving mode). In an example, a first assisted driving mode can be a hands-off driving mode, and a second assisted driving mode is a hands-on driving mode. Alternatively or in addition to, block 435 can include discontinuing adaptive cruise control of vehicle 102, thereby placing the operator of the vehicle in control of the vehicle’s speed. After completion of block 435, the process 400 ends.

After decreasing the speed of vehicle 102 at block 430, process 400 can continue at block 440. Block 440 can include computer 110 again determining whether one or more of the operator’s hands have been placed into contact with the steering wheel of vehicle 102. Based on a signal or data from a steering wheel sensor of the vehicle, block 435 is executed at which computer 110 can transition from a first assisted driving mode (e.g., autonomous or semi-autonomous) to a second driving mode (e.g., a manual driving mode). At block 445, based on an absence of a signal or data from a steering wheel sensor of the vehicle, computer 110 may determine whether vehicle 102 has come to a stop. Based on vehicle 102 coming to a stop at block 450, process 400 ends.

After execution of block 450, block 440 may again be executed based on computer 110 determining that vehicle 102 continues to be in motion. Block 440 may be executed a second time to determine if the operator of vehicle 102 has placed a hand into contact with the steering wheel of the vehicle. Based on an absence of a signal or data from a steering wheel sensor indicating that the operator has placed a hand into contact with the steering wheel of vehicle 102, block 445 may again be actuated. In an example, actuator 125 can include propulsion component 129, which can operate to reduce the speed of vehicle 102 by five kilometers per hour, 10 kilometers per hour, or another decrease in the speed of the vehicle.

It is noted that blocks 440, 445, and 440 can be repeated (e.g., twice, three times, four times, etc.) in which the speed of vehicle 102 is gradually or incrementally reduced so long as steering wheel sensor (115) indicates an absence of one or more of the operator’s hands in contact with the steering wheel of the vehicle.

Operations, systems, and methods described herein should always be implemented and/or performed in accordance with an applicable owner’s/user’s manual and/or safety guidelines and/or in accordance with applicable laws and/or regulations.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above and is accessed via a network in any one or more of a variety of manners. A file system may be accessible from a computer operating system and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It should be understood further that certain steps could be performed simultaneously, that other steps could be added, or that certain steps described herein could be omitted.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. The adjectives “first” and “second” are used throughout this document as identifiers and are not intended to signify importance, order, or quantity. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system, comprising a computer including a processor and memory, the memory storing instructions executable by the processor to:
determine a deviation between a digitally mapped version of an upcoming road feature and an upcoming road feature detected at a vehicle;
determine, based on a speed of the vehicle, a time interval available prior to the vehicle encountering the deviation between the digitally mapped version and the detected upcoming road feature; and
actuate a component, during the time interval, for a transition from a first assisted driving mode to a second assisted driving mode.

2. The system of claim 1, wherein the component outputs an audio signal or a vibration in a seat and/or steering wheel of the vehicle.

3. The system of claim 1, wherein the instructions to actuate the component include instructions to:
actuate the component to decrease speed of the vehicle.

4. The system of claim 1, wherein the instructions further include instructions to:
initiate a timer at the vehicle after executing the instructions to actuate the component; and
actuate a second component of the vehicle to decrease speed based on expiration of the timer.

5. The system of claim 1, wherein the deviation between the digitally mapped version of the upcoming road feature and the detected upcoming road feature is based on detection by a second vehicle of the deviation between the digitally mapped version of the upcoming road feature and the detected upcoming road feature.

6. The system of claim 1, wherein the deviation between the digitally mapped version of the upcoming road feature and the detected upcoming road feature is based on detection by a second vehicle of the deviation between the digitally mapped version of the upcoming road feature and the detected upcoming road feature and based on an output from a facial recognition component of the second vehicle indicating emotional discomfort of an operator or a passenger of the second vehicle.

7. The system of claim 1, wherein the deviation between the digitally mapped version of the upcoming road feature and the detected upcoming road feature is based on detection by a second vehicle of the deviation between the digitally mapped version of the upcoming road feature and the detected upcoming road feature and based on data from a lateral accelerometer of the second vehicle.

8. The system of claim 1, wherein the deviation between the digitally mapped version of the upcoming road feature and the detected upcoming road feature is based on detection by a second vehicle of the deviation between the digitally mapped version of the upcoming road feature and the detected upcoming road feature and based on data from a longitudinal accelerometer of the second vehicle.

9. The system of claim 1, wherein the deviation between the digitally mapped version of the upcoming road feature and the detected upcoming road feature is based on a probability of a presence of the deviation, based on inputs from a database utilizing inputs of operators of one or more other vehicles, between the digitally mapped version of the upcoming road feature and the detected upcoming road feature.

10. The system of claim 9, wherein an output of a human-machine interface (HMI) is based on the probability.

11. The system of claim 1, wherein the deviation between the digitally mapped version of the upcoming road feature and the detected upcoming road feature includes a difference between road curvature represented on the digital map and a detected road curvature.

12. The system of claim 1, wherein the deviation between the digitally mapped version of the upcoming road feature and the detected upcoming road feature includes a difference between a recommended speed based on the digital map and a recommended speed based on the detected upcoming road feature exceeding a measure of roughness of the surface of the upcoming road.

13. The system of claim 1, wherein the deviation between the digitally mapped version of the upcoming road feature and the detected upcoming road feature includes a difference between an expected and a detected angle of incline of the upcoming road.

14. The system of claim 1, wherein the time interval is based on a geofence boundary between a location of the vehicle and the detected upcoming road feature.

15. The system of claim 1, wherein the first assisted driving mode is a hands-off driving mode and wherein the second assisted driving mode is a hands-on driving mode.

16. The system of claim 1, wherein the deviation between the digitally mapped version of the upcoming road feature and the detected upcoming road feature is based on road descriptions from the digital map and detected road markings.

17. The system of claim 1, wherein the time interval is based on gross train weight of the vehicle.

18. A method, comprising:
determining a deviation between a digitally mapped version of an upcoming road feature and an upcoming road feature detected at a vehicle;
determining, based on a speed of the vehicle, a time interval available prior to the vehicle encountering the deviation between the digitally mapped version and the detected upcoming road feature; and
actuating a component, during the time interval, for a transition from a first assisted driving mode to a second assisted driving mode.

19. The method of claim 18, comprising:
actuating the component to decrease the speed of the vehicle.

20. The method of claim 19, wherein the deviation between the digitally mapped version of the upcoming road feature and the detected upcoming road feature are based on a combined deviation of two or more of a difference between road curvature represented on the digital map and a detected road curvature, a sensed or detected speed of the vehicle, a measure of the roughness of a road, a measure of road friction, night versus day driving, and ambient weather conditions.
